(19) United States
(12) Patent Application Publication
(10) Pub. No.: US 2010/0185954 A1
(43) Pub. Date: Jul. 22, 2010

(54) Collaborative Environment Project Extensibility with Composition Containers

(75) Inventors: Iouri Borisovitch Simernitski, Redmond, WA (US); Vladimir Yuryevich Morozov, Sammamish, WA (US); Nikhil Khandelwal, Seattle, WA (US); Phillip Michael Hoff, Duvall, WA (US); Lubomir Birov, Redmond, WA (US); Michael William Morton, Woodinville, WA (US)

Correspondence Address: MICROSOFT CORPORATION, ONE MICROSOFT WAY, REDMOND, WA, 98052, US

(73) Assignee: Microsoft Corporation, Redmond, WA (US)

(21) Appl. No.: 12/356,607

(22) Filed: Jan. 21, 2009

(51) Int. Cl. G06F 3/00

(52) U.S. Cl. 715/751

(57) ABSTRACT

Dynamic collaborative project extensibility is provided via composition containers in a managed extensibility framework within an integrated development environment. A browser-based collaborative environment project is extended, using an extension artifact factory to obtain extension artifacts within composition containers. A class library project can be configured with a custom action, a browser-based collaborative environment project extension artifact can be created representing the custom action, and a factory class for the project extension artifact can then be created with an export attribute for discovery within a composition container.

### BACKGROUND

A collaborative environment can be provided with computer networking technology which aids communication between people who are geographically separated. Collaborative communication may occur through email discussion lists, teleconferencing tools, and shared documents such as annotatable blogs and wikis, for example.

A collaborative environment may be browser-based. That is, one or more applications provided in the collaborative environment may be accessed by human users through their web browsers. In some configurations, a web browser may be enhanced by one or more plug-ins; functionality accessed by a web browser may also be enhanced by changes made to a web server. In addition to providing a graphical user interface to networked tools, a web browser may access collaborative services which are hosted by one or more servers in a collaborative environment's underlying network infrastructure. In some collaborative environments, applications such as word processors or spreadsheets access collaborative environment web services to access data in a shared store.

### SUMMARY

Some embodiments provide dynamic collaborative project extensibility via composition containers, allowing collaborative runtime flexibility beyond the mere capabilities of plug-ins. For example, a browser-based collaborative environment project may be extended using an extension artifact factory to obtain one or more instances of a browser-based collaborative environment project extension artifact within a composition container. A project may be an extension for a collaborative environment, such as a Microsoft SharePoint® environment; project system extensibility can make a SharePoint® development environment more flexible. In some embodiments, a project is configured with a custom action, a browser-based collaborative environment project extension artifact is created representing the custom action, and a factory class for the project extension artifact is then created with an export attribute making it visible outside a composition container. In some embodiments, developers add an extension for each of a plurality of artifact types in a collaborative environment. In some embodiments, a collaborative project factory is located and used to identify a collaborative project extension artifact factory, which is then used to create an instance of a collaborative project extension artifact in a composition container in a networked computing system.

The examples given are merely illustrative. This Summary is not intended to identify key features or essential features of the claimed subject matter, nor is it intended to be used to limit the scope of the claimed subject matter. Rather, this Summary is provided to introduce—in a simplified form—some concepts that are further described below in the Detailed Description. The innovation is defined with claims, and to the extent this Summary conflicts with the claims, the claims should prevail.

### DESCRIPTION OF THE DRAWINGS

A more particular description will be given with reference to the attached drawings. These drawings only illustrate selected aspects and thus do not fully determine coverage or scope.

FIG. 1 is a block diagram illustrating a computer system having at least one processor, at least one memory, at least one browser for running one or more applications, and other items in an operating environment which may be present on multiple network nodes, and also illustrating configured storage medium embodiments;

FIG. 2 is a block diagram illustrating an architecture for collaborative project extensibility in conjunction with an integrated development environment which provides composition container management;

FIG. 3 is a data flow diagram illustrating project extension initialization in an example architecture; and

FIG. 4 is a flow chart illustrating steps of some method and configured storage medium embodiments.

### DETAILED DESCRIPTION

Overview

Collaborative environments provide tools which facilitate interaction between people despite their geographic separation. Microsoft provides a family of collaborative environments under the mark SharePoint®, including, for example, technologies and tools to facilitate workgroup collaboration and document creation and management, meeting and event scheduling and notification, project management, and transmission of messages among computer users. In some configurations, Microsoft SharePoint® technology allows a group to configure portals and hierarchies of websites without specifically requiring web-development, which helps people find, create, collect, organize, and collaborate information in a browser-based environment. Views of the various collections of information can be filtered, grouped, and/or sorted according to the wishes of each person. Permissions can be structured to reflect each person's organizational role, team membership, or interest, for instance.

However, extensions to SharePoint® environments, including development environments, by independent software providers have been somewhat lacking, in part because SharePoint® solution developers have found it necessary to use a variety of tools from different sources to develop even a simple SharePoint® solution. When development tools fall short, infrastructure to extend them with new or improved functionality has been insufficient.

Infrastructure to support independent additions to SharePoint® environments could take various forms. For instance, in general the functionality of a software application may be extended by a developer with code which is defined as part of the software before the software runs. Software development often includes writing source code, compiling the source into executable machine code or virtual machine code, and linking or otherwise binding the compiled result to previously created code.

Some architectures allow the functionality of an application to be extended while an end-user is running the application. For example, some applications support plug-ins, which are relatively small pieces of application-specific software that can be loaded by (or on behalf of) an application at runtime. Plug-ins enhance an application, rather than running on their own. Plug-ins are optional, in that the application provides substantial functionality even without plug-ins. Plug-ins are application-specific, being designed and implemented to operate with a particular application, and sometimes even with a particular version of that application. Each application provides its own infrastructure for locating and using the plug-in(s) it supports. Plug-ins are also called “add-ons” or “add-ins”.

Another approach to functionality extension requires an extensibility framework which allows an application to both discover and utilize software functionality at runtime. Within the framework, an infrastructure supports sharing functionality among different applications, as well as application-specific extensions. Such applications are termed “extensible”. An extensibility framework provides mechanisms for an application to locate and load available extensions, based on signatures and/or other data type information associated with the extensions and the applications. For instance, an extensible application environment may include composition containers which import/export values among one another.

Microsoft provides an extensible application environment known as “MEF” (“Managed Extensibility Framework”). MEF provides runtime extensibility without imposing a plug-in model on applications. MEF permits a host application to expose its own extensions (namely, components, services, and/or component providers) and to consume external extensions. Extensions can be reused amongst different applications, and can also be implemented as application-specific. Extensions can depend on one another; MEF connects the extensions automatically, based on contracts, types, and/or other constraints. MEF offers discovery mechanisms for an application to locate and load available extensions. MEF also supports tagging extensions with metadata which facilitates querying and filtering.

MEF allows a runtime to discover and bind components together. In order for a component to be found according to some embodiments herein, the component is given a special “Export” custom attribute. For instance, some component factories have this Export attribute and as a result can be discovered and used by a project. The project can use factories to create extensions for an artifact instance in the project; a project may have zero or more artifacts in it.

In MEF, composition containers are used to bind components together. An application itself can export some components, services, or component providers which can be consumed by add-on components. An application imports components, services, or component providers from the add-on components. Add-ons in turn export components, services, and component providers and import the needed elements from the application.

Thus, a composition container receives available metadata from the application and add-ons and binds them together. A composition container can create instances of an object if needed, so composition containers do not necessarily provide import/export of objects between each other. The metadata is provided to the component container using a component resolver. A special type of component resolver can take or import components from another component container, in some configurations; this type of resolver is not necessarily present in every configuration.

MEF's core constructs include catalogs and composition containers. A catalog is responsible for discovering extensions (namely, components, services, and/or component providers), while composition containers coordinate item creation and satisfy dependencies. In MEF, a composable part offers up one or more exports, and may also depend on one or more externally provided services or other imports. A composable part also manages an instance, which can be an object instance of a given type. MEF is extensible; additional composable part implementations can be provided as long as they adhere to specified import/export contracts. Contracts are a bridge between exports and imports. An export contract can include metadata that can be used to filter discovery of the export, e.g., by indicating a specific capability offered by the export.

Some embodiments described herein provide a mechanism for extending collaborative environment projects using a managed extensibility framework. Some embodiments include a Microsoft Visual Studio® project system that offers core infrastructure and an extensibility model for Microsoft SharePoint® project extensions, allowing integration of project system operation from project creation through debugging to deployment. This extensible architecture enables third parties as well as Microsoft to provide extensions with additional SharePoint® targeting functionality while maintaining seamless integration into an existing project. Accordingly, users can benefit from an integrated project development environment for SharePoint® project extensions, and an extensible project development environment for SharePoint® applications. Users can utilize project types inside the Visual Studio® environment to create SharePoint® list definitions, site definitions, workflows, webparts, mapped folders and other artifacts. In addition, managed APIs and documented file formats can be used to create extensions to those project types as well as to create new project types. A software development lifecycle can be followed for SharePoint® applications, including development, source control, testing, deployment, and debugging. Standard projects as well as third party extensions can participate in the software development lifecycle for any supported version of a SharePoint® environment, regardless of the version and processor architecture (32-bit or 64-bit) of that SharePoint® environment.

Reference will now be made to exemplary embodiments such as those illustrated in the drawings, and specific language will be used herein to describe the same. But alterations and further modifications of the features illustrated herein, and additional applications of the principles illustrated herein, which would occur to one skilled in the relevant art(s) and having possession of this disclosure, should be considered within the scope of the claims.

The meaning of terms is clarified in this disclosure, so the claims should be read with careful attention to these clarifications. Specific examples are given, but those of skill in the relevant art(s) will understand that other examples may also fall within the meaning of the terms used, and within the scope of one or more claims. Terms do not necessarily have the same meaning here that they have in general usage, in the usage of a particular industry, or in a particular dictionary or set of dictionaries. Reference numerals may be used with various phrasings, to help show the breadth of a term. Omission of a reference numeral from a given piece of text does not necessarily mean that the content of a Figure is not being discussed by the text. The inventors assert and exercise their right to their own lexicography. Terms may be defined, either explicitly or implicitly, here in the Detailed Description and/or elsewhere in the application file.

As used herein, a “computer system” may include, for example, one or more servers, motherboards, processing nodes, personal computers (portable or not), personal digital assistants, cell or mobile phones, and/or device(s) providing one or more processors controlled at least in part by instructions. The instructions may be in the form of software in memory and/or specialized circuitry. In particular, although it may occur that many embodiments run on workstation or laptop computers, other embodiments may run on other computing devices, and any one or more such devices may be part of a given embodiment.

A “multithreaded” computer system is a computer system which supports multiple execution threads. The term “thread” should be understood to include any code capable of or subject to synchronization, and may also be known by another name, such as “task,” “process,” or “coroutine,” for example. The threads may run in parallel, in sequence, or in a combination of parallel execution (e.g., multiprocessing) and sequential execution (e.g., time-sliced). Multithreaded environments have been designed in various configurations. Execution threads may run in parallel, or threads may be organized for parallel execution but actually take turns executing in sequence. Multithreading may be implemented, for example, by running different threads on different cores in a multiprocessing environment, by time-slicing different threads on a single processor core, or by some combination of time-sliced and multi-processor threading. Thread context switches may be initiated, for example, by a kernel's thread scheduler, by user-space signals, or by a combination of user-space and kernel operations. Threads may take turns operating on shared data, or each thread may operate on its own data, for example.

A “logical processor” or “processor” is a single independent hardware thread. For example a hyperthreaded quad core chip running two threads per core has eight logical processors. Processors may be general purpose, or they may be tailored for specific uses such as graphics processing, signal processing, floating-point arithmetic processing, encryption, I/O processing, and so on.

A “multiprocessor” computer system is a computer system which has multiple logical processors. Multiprocessor environments occur in various configurations. In a given configuration, all of the processors may be functionally equal, whereas in another configuration some processors may differ from other processors by virtue of having different hardware capabilities, different software assignments, or both. Depending on the configuration, processors may be tightly coupled to each other on a single bus, or they may be loosely coupled. In some configurations the processors share a central memory, in some they each have their own local memory, and in some configurations both shared and local memories are present.

“Kernels” include operating systems, hypervisors, virtual machines, and similar hardware interface software.

“Code” means processor instructions, data (which includes constants, variables, and data structures), or both instructions and data.

Throughout this document, use of the optional plural “(s)” means that one or more of the indicated feature is present. For example, “container(s)” means “one or more containers” or equivalently “at least one container”.

Whenever reference is made to data or instructions, it is understood that these items configure a computer-readable memory thereby transforming it to a particular article, as opposed to simply existing on paper, in a person's mind, or as a transitory signal on a wire, for example.

Operating Environments

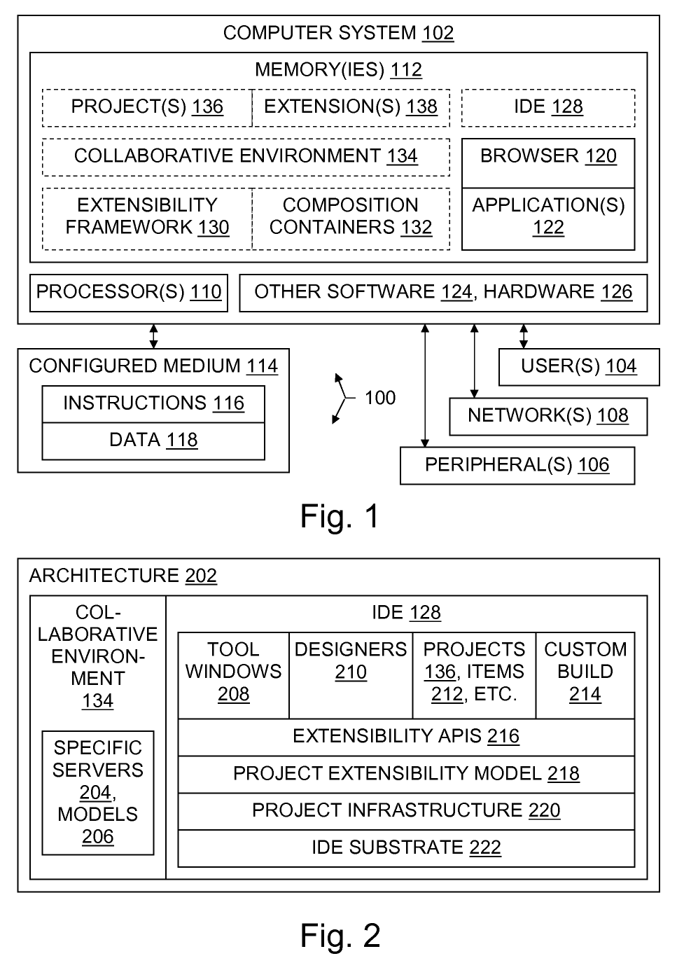

With reference to FIG. 1, an operating environment 100 for an embodiment may include a computer system 102. The computer system 102 may be a multiprocessor computer system, or not. An operating environment may include one or more machines in a given computer system, which may be clustered, client-server networked, and/or peer-to-peer networked.

Human users 104 may interact with the computer system 102 by using displays, keyboards, and other peripherals 106. System administrators, developers, engineers, and end-users are each a particular type of user 104. Automated agents acting on behalf of one or more people may also be users 104. Storage devices and/or networking devices may be considered peripheral equipment in some embodiments. Other computer systems not shown in FIG. 1 may interact with the computer system 102 or with another system embodiment using one or more connections to a network 108 via network interface equipment, for example.

The computer system 102 includes at least one logical processor 110. The computer system 102, like other suitable systems, also includes one or more memories 112. The memories 112 may be volatile, non-volatile, fixed in place, removable, magnetic, optical, and/or of other types. In particular, a configured medium 114 such as a CD, DVD, memory stick, or other removable non-volatile memory medium may become functionally part of the computer system when inserted or otherwise installed, making its content accessible for use by processor 110. The removable configured medium 114 is an example of a memory 112. Other examples of memory 112 include built-in RAM, ROM, hard disks, and other storage devices which are not readily removable by users 104.

The medium 114 is configured with instructions 116 that are executable by a processor 110; “executable” is used in a broad sense herein to include machine code, interpretable code, and code that runs on a virtual machine, for example. The medium 114 is also configured with data 118 which is created, modified, referenced, and/or otherwise used by execution of the instructions 116. The instructions 116 and the data 118 configure the memory 112/medium 114 in which they reside; when that memory is a functional part of a given computer system, the instructions 116 and data 118 also configure that computer system. In some embodiments, a portion of the data 118 is representative of real-world items such as product characteristics, inventories, physical measurements, settings, images, readings, targets, volumes, and so forth. Such data is also transformed by as discussed herein, e.g., by binding, deployment, execution, modification, display, creation, loading, and/or other operations.

Memories 112 may be of different physical types. A web browser 120, applications 122 accessed through the browser, other software 124, and other items shown in the Figures may reside partially or entirely within one or more memories 112, thereby configuring those memories. An operating environment may also include other hardware 126, such buses, power supplies, and accelerators, for instance.

A given operating environment 100 may include an Integrated Development Environment (IDE) 128 which provides a developer with a set of coordinated software development tools. In particular, some of the suitable operating environments for some embodiments include or help create a Microsoft® Visual Studio® development environment (marks of Microsoft Corporation) configured to support program development. Some suitable operating environments include Java® environments (mark of Sun Microsystems, Inc.), and some include environments which utilize languages such as C++ or C# (“C-Sharp”), but teachings herein are applicable with a wide variety of programming languages, programming models, and programs, as well as with endeavors outside the field of software development per se that use extensible application environments, collaborative technologies, or both.

Several items are shown in outline form in FIG. 1 to indicate that they are not necessarily part of the illustrated operating environment, but may interoperate with items in the operating environment as discussed herein. Examples include an extensibility framework 130, such as MEF or another framework providing dynamically-determined matches between class instances based on contracts and type signatures; composition containers 132 such as MEF composition containers or other containers of importable/exportable dynamically matched typed class instances; a collaborative environment such as a SharePoint® environment or another browser-based workgroup/document collaboration technology; projects 136 such as Visual Studio® IDE projects or other integrated development environment projects; and project extensions 138 which extend the function of projects 136 in coordination with the IDE 128.

Systems

FIG. 2 illustrates an architecture 202 which is suitable for use with some embodiments. A collaborative environment 134, such as a SharePoint® environment, includes specific technologies and tools such as servers 204 and models 206. For example, servers 204 may include SharePoint® servers such as a Windows SharePoint Services add-on to Microsoft Windows Server, and a Microsoft Office SharePoint Server package. Models 206 may include, for example, SharePoint® object models such as a server-side object model, a client-side object model, and a SharePoint application-specific adapter model. Tool windows 208 may include package explorers and server explorers, for example. Designers 210 may include package designers and feature designers, for example. Projects 136 have associated project items 212 (items 212 are also referred to herein as “artifacts”), and may have associated templates and wizards. Some examples of project-associated components include website definition projects, list definition projects, event artifacts, web part artifacts, application page artifacts, workflow projects, and wizards for projects or project artifacts. A custom build process manager manages builds of projects and their custom extensions in the IDE 128. Tool windows 208, designers 210, projects 136, project items 212, and custom builders 214 may be tools provided by the collaborative environment in conjunction with the IDE, for instance.

One or more extensibility APIs 216 provide coordination between the collaborative projects and their extensions within the IDE. The APIs interact with a project extensibility model 218 (an example of a model 206) and a project infrastructure 220 which are designed to support software development of collaborative tools within the IDE, based in turn on an IDE substrate 222. In the Visual Studio® IDE, for example, the substrate 222 may include a Visual Studio® shell, Visual Studio® packages, and a top-level DTE (development tools extensibility) object. Some embodiments provide a SharePoint® project extensibility model 218 and a SharePoint® project infrastructure 220. A project extensibility model 218 may include, for example, a project which loads project extensions and communicates with them using shared contract interfaces of an API 216. A project infrastructure 220 may include, for example, user interface components such as a hierarchy, property browser, property pages, menus, and F1 “help key” handlers; source code control; configuration support for building, debugging, publishing, and deploying code; upgrade support, and new item addition support.

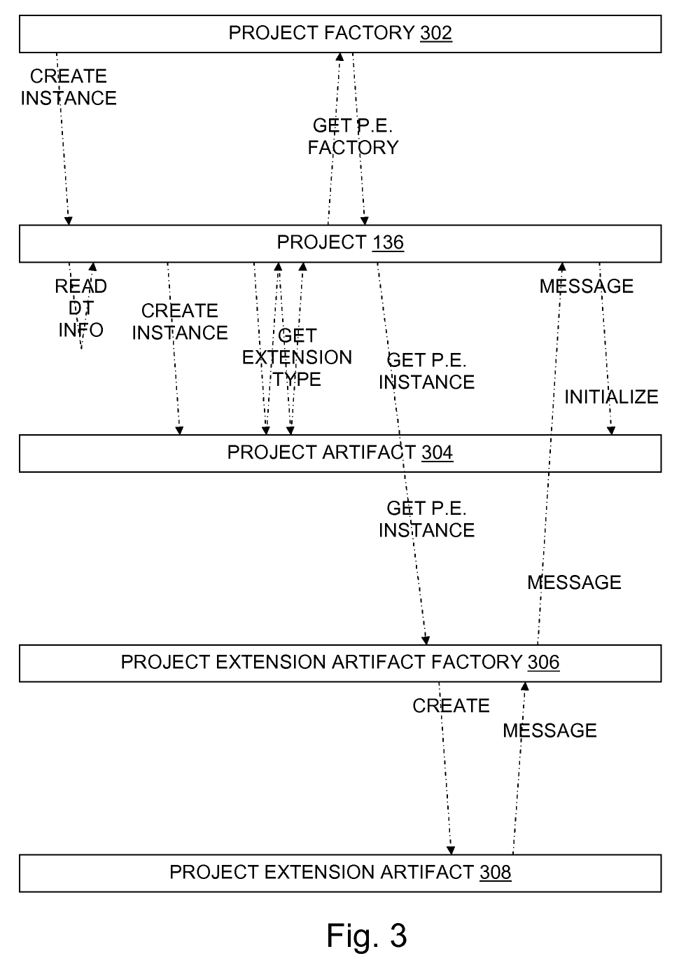

FIG. 3 illustrates initialization of a project extension within an example architecture. A project factory 302 creates an instance of a project 136, which reads data type information and creates an instance of a project artifact 304 (also referred to as a “project item”). Extension type information is obtained, and a project extension (“P.E.”) instance is made, using a project extension artifact factory 306 to create a project extension artifact 308. Successful creation of the project extension artifact 308 is messaged upward, and the project artifact is initialized accordingly.

Some embodiments are designed to provide a unified project and workflow building block for a developer, such as a unified project system which could be extended with building blocks to support different types of artifact development for a SharePoint® environment 134. One implementation approach uses the Visual Studio® Tools for Office 2008 workflow project as a starting point, because it contains an implementation of a released version of one building block, namely, workflows. Some code was written in C++ and C++/CLI, and translated to C# to permit development completely in managed code. As a step toward a unified project system, the managed workflow project infrastructure 220 was split into a unified project system base and a workflow building block, which also helped identify the interaction API 216 between the unified project and the workflow block, and between the project and any other blocks.

A high level architectural view of this approach includes a Unified Project infrastructure 220 component, which is a core of the SharePoint® project system free of workflow-specific code; a Workflow Building Block infrastructure 220 which has all workflow-specific code; and Contracts which are a set of interfaces, enumerators and structs shared between the project and workflow building block. In one approach, Contracts are part of an API 216 that is free of implementing code which would complicate versioning. Within the API 216, IProjectService and ILogger interfaces are implemented by the project system, while IArtifactFactory, IArtifact, IPersistSettings, and IDeploymentHandle interfaces are implemented by a building block such as the Workflow Building Block (the phrase “building block” has been used internally interchangeably with “artifact” and “SharePoint project item”). It will be understood that the names of these interfaces may have changed and/or that different names may be used; these are merely examples.

In this embodiment, an IProjectService interface implemented by the project system provides functionality for use by Building Blocks:

```
  public interface IProjectService
  {
    string ProjectName { get; }
    ReadOnlyCollection<IArtifact> Artifacts { get; }
    string GetProjectItemFullPath(string sourceFile);
    int GetProjectOutputFullPath(out string
projectOutputPath);
    void PreloadAssembly(string assemblyPath);
  }
```

In this embodiment, an ILogger interface implemented by the project system provides an ability to communicate messages to an output window:

```
  public interface ILogger
  {
    void Write(string message, LogCategory category);
    void WriteLine(string message, LogCategory
category);
  }
```

With regard to Building Block interfaces, an IArtifactFactory interface in this embodiment is used by the project system to create an instance of artifact:

```
  public interface IArtifactFactory
  {
    IArtifact CreateArtifact(Guid id, IProjectService
project);
  }
```

An IArtifact interface in this embodiment is the main interface implemented by a building block:

```
public interface IArtifact
{
  IPersistSettings PersistSettings { get; }
  IDeploymentHandler CreateDeploymentHandler( );
  object Model { get; }
  Uri DebugUrl { get; }
  bool CanDebug { get; }
}
```

An IPersistSettings interface in this embodiment can be implemented by a building block in order to persist data in the project User file:

```
public interface IPersistSettings
{
  bool IsDirty { get; set; }
  void LoadFromXml(XElement element);
  void SaveToXml(XElement element);
}
```

An IDeploymentHandler interface in this embodiment is an interface used to communicate with a deployment subsystem; this interface can be replaced by a different mechanism implemented as a part of a project deployment subsystem:

```
  public interface IDeploymentHandler
  {
    bool IsDeploying { get; }
    bool IsCompleted { get; }
    bool IsCanceled { get; }
    int InitDeploymentSession(Action<bool>
deployNotificationCallback);
    int BeginCancelDeployment( );
    int Deploy( );
  }
```

With regard to the extensibility framework 130, one implementation approach uses a Managed Extensibility Framework (MEF) within a Visual Studio® IDE 128 to help provide extensibility on the top of a Visual Studio® substrate 222. MEF allows code to bind components which do not necessarily have reference to each other; if they are in the same CompositionContainer (a.k.a., ComponentDomain, e.g., the same composition container 132) and if they export and import the same contract then they can be bound together. The contract is represented by a string, e.g., an XName. The MEF extensibility framework 130 tries to match imports and exports, and generates proxy objects if it cannot find a shared interface type. Binding can fail if no common ground is found.

To implement MEF between the unified project and the workflow block, that is, to connect the project system to the artifact(s) through MEF, an IComponentDomain service can be used:

```
  internal interface IComponentDomain
  {
    void AddComponents(params object[ ] components);
    /// <summary>
    /// Returns collection of components of requested
type.
    /// </summary>
    IEnumerable<T> GetComponents<T>( ) where T : class;
    /// <summary>
    /// Requests a singleton component which is usually
a service.
    /// </summary>
    T GetService<T>( ) where T : class;
  }
```

In one approach, a SharePointProjectFactory (an example of a project factory 302) imports IArtifactFactory, and a WorkFlowArtifactFactory exports IArtifactFactory. Logger exports ILogger, and the WorkFlowArtifactFactory imports ILogger. A class ComponentDomainService implements the IComponentDomain interface and is initialized in the project package. One system includes two components in the project (SharePointProjectFactory and Logger), and one component for the workflow Building Block (WorkfowArtifactFactory). These components are singletons and are used to establish connections between the project system and the building block. As soon as the connection is established using MEF, these components can call methods and properties of each other in a manner similar to what they would do without MEF. This approach utilizes a relatively simple programming model, namely, factories and singleton services establish communication using MEF, and specific instances of objects are created and then used in the way they would be used without MEF.

With regard to project artifact collection implementation, in one approach an IProjectService has a read-only collection of Artifacts; the contents of this collection cannot be changed from outside IProjectService. The collection of artifacts is changed depending on contents of the project hierarchy, e.g., new artifacts can be added, or some artifacts can be removed, as a result of user interaction with the project system. The Artifacts collection provides a way to subscribe to change events using INotifyCollectionChanged and INotifyPropertyChanged interfaces:

```
  ((INotifyCollectionChanged)_artifacts).CollectionChanged +=
this.HandleCollectionChanged;
  ((INotifyPropertyChanged)_{—} artifacts).PropertyChanged +=
this.HandlePropertyChanged;
```

This design may be changed to make the event handlers more visible.

In one approach, the design of an internal implementation of the Artifacts collection was driven by several constraints. First, collection content should depend on Hierarchy content; the collection should have a way to react to IVsHierarchy changes. Second, the collection should not be changeable from outside. Third, the collection should provide events notifying its subscribers about change events. A relatively close standard class found in the Microsoft Common Language Runtime (CLR) is the ReadOnlyObservableCollection<T> which can wrap up ObservableCollection<T>. However, the ReadOnlyObservableCollection<T> class does not expose events as public members, which makes it arguably not more useful for an external API than just ReadOnlyCollection<T>. So, one design exposes the ReadOnlyCollection<IArtifact> which can be type-casted to the event interfaces INotifyCollectionChanged and INotifyPropertyChanged. An internal implementation may use benefits of the ReadOnlyObservableCollection<T> to provide greater internal functionality.

In one Artifacts collection implementation, an internal class ArtifactCollection is inherited from public CLR class ReadOnlyCollection<IArtifact>; ArtifactCollection uses an internal class ArtifactInfoCollection, which is inherited from an internal class HierarchyItemCollection<T>, which is inherited from public CLR class ReadOnlyObservableCollection<T>. The HierarchyItemCollection<T> collection is inherited from the ReadOnlyObservableCollection<T> and keeps its content synchronized with the items in the provided IVsHierachy; it represents a filtered view of all items in the provided IVsHierarchy, and uses the OnTryCreateHierarchyItem method to ask inheritors to create an item of type T for each new IVsHierarchy item. ArtifactInfoCollection is inherited from HierarchyItemCollection<ArtifactInfo> and provides an implementation for the OnTryCreateHierarchyItem method creating an ArtifactInfo class instance for each IVsHierarchy item containing artifact-specific metadata, looking among <None> content in the Visual Studio® project file for two item tags, namely, ArtifactFactoryId and ArtifactId, for example:

```
<None Include=“MyArtifact.artx”>
  <ArtifactFactoryId>Workflow</ArtifactFactoryId>
  <ArtifactId>f8f40d7b-6cfe-40f0-8217-
5b8b95cb9499</ArtifactId>
</None>
```

An ArtifactFactoryId contains an identifier used to find the artifact factory. In this approach, the ArtifactId is the GUID identifying an instance of an artifact. A project may have multiple artifacts of the same type; each of them will have its own unique GUID, but the same factory identifier. ArtifactInfo is a simple class which has a reference to an IArtifact instance and any internally used information about the artifact such as the ArtifactId GUID. ArtifactCollection's collection is inherited from the ReadOnlyCollection<IArtifact> and wraps up data from the ArtifactInfoCollection. ArtifactCollection subscribes to and exposes the content changing events; it also does a conversion between ArtifactInfo and IArtifact instances.

In this approach, text resources can be split between two projects, e.g., while placing workflow-specific code in a separate assembly.

At least two options can be followed with regard to commands appearing as a part of Visual Studio® menu or context menu, since all user interface elements may need to be precompiled and installed into a Microsoft Windows® registry to optimize Visual Studio® IDE loading. One option is to define some predefined commands and change their visibility and text depending on the active building block. Another option is to define places where a set of dynamic commands can be inserted by building blocks. Visual Studio® IDE provides a dynamic menu mechanism implemented for MRU files and external tools references.

An alternative approach is illustrated by the API 216 interfaces listed at the end of the current description, titled “Alternate API Listing”.

With reference to FIGS. 1 through 3, some embodiments provide a computer system 102 with a logical processor 110 and a memory 112 configured by circuitry, firmware, and/or software to transform a collaborative project 136 by extending functionality with composition container 132 exports/imports as described herein. For example, in some embodiments a browser-based collaborative environment project 136 configures memory 112 in operable communication with the logical processor 110, a browser-based collaborative environment project extension artifact factory 306 likewise configures memory, and a browser-based collaborative environment project extension artifact 308 within a composition container 132 likewise configures memory.

In some embodiments, the code configuring the memory includes a managed extensibility framework 130 designed for managing at least some of the composition containers. For instance, a system may be configured with a Microsoft MEF framework 130. The composition container 132 may be part of a system configured by an extensibility framework 130 that includes a catalog, registry, database, query, or other discovery mechanism for locating extensions in composition containers. Some extensibility frameworks include attribute tags, a database, or another mechanism for associating metadata with an extension, to aid filtering, for example, when seeking extensions that have specified characteristics.

In some embodiments, the system 102 code configuring the memory includes an API 216 for a browser-based collaborative environment project extension artifact factory. In some, the system includes code (e.g., in the infrastructure 220) configuring the memory and making the system capable of managing a collection of browser-based collaborative environment project extension artifacts 308, and the collection is publicly read-only. In some, the system has infrastructure 220 code configuring the memory and making the system capable of notifying subscribers of changes in a collection of browser-based collaborative environment project extension artifacts 308, such as web part(s), workflow(s), and/or mapped folder(s).

The system may include an integrated development environment 128, which configures memory in operable communication with the logical processor. In some embodiments, the system includes code (in the infrastructure 220 and/or the IDE substrate 222) configuring the memory and including an API specifically designed for facilitating operations such as deploying, executing, debugging, and modifying a browser-based collaborative environment project extension, e.g., by performing such operation(s) on one or more project extension artifact factories 306 and/or one or more project extension artifacts 308.

In some embodiments peripherals 106 such as human user I/O devices (screen, keyboard, mouse, tablet, microphone, speaker, motion sensor, etc.) will be present in operable communication with one or more processors 110 and memory 112. However, an embodiment may also be deeply embedded in a system, such that no human user 104 interacts directly with the embodiment. Software processes may be users 104.

In some embodiments, the system includes multiple computers connected by a network in a browser-based collaborative environment. Networking interface equipment can provide access to networks 108, using components such as a packet-switched network interface card, a wireless transceiver, or a telephone network interface, for example, will be present in a computer system. However, an embodiment may also communicate through direct memory access, removable nonvolatile media, or other information storage-retrieval and/or transmission approaches, or an embodiment in a computer system may operate without communicating with other computer systems.

Methods

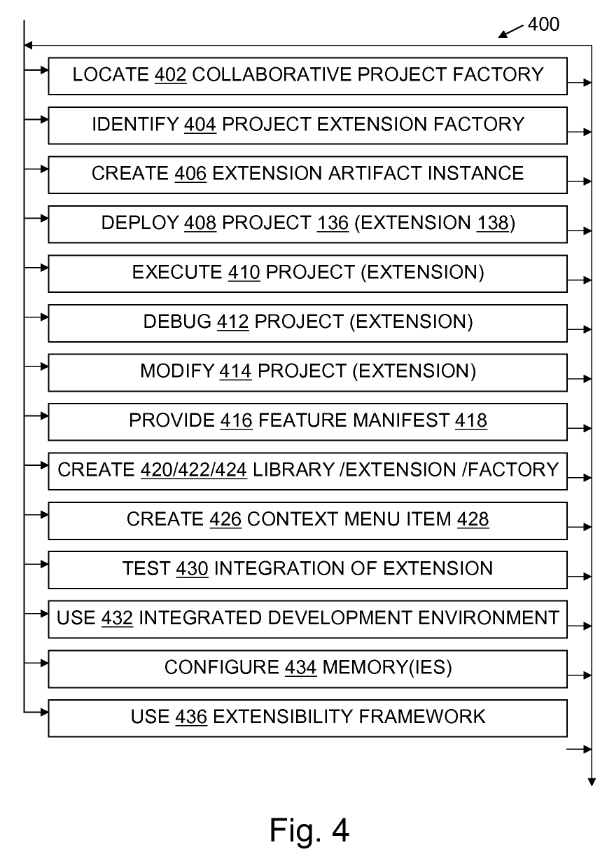

FIG. 4 illustrates some method embodiments in a flowchart 400. Methods shown in the Figures may be performed in some embodiments automatically, e.g., by a collaborative environment 134, project 136, extensibility framework 130, and composition containers 132 under control of a script requiring little or no user input. Methods may also be performed in part automatically and in part manually unless otherwise indicated. In a given embodiment zero or more illustrated steps of a method may be repeated, perhaps with different parameters or data to operate on. Steps in an embodiment may also be done in a different order than the top-to-bottom order that is laid out in FIG. 4. Steps may be performed serially, in a partially overlapping manner, or fully in parallel. The order in which flowchart 400 is traversed to indicate the steps performed during a method may vary from one performance of the method to another performance of the method. The flowchart traversal order may also vary from one method embodiment to another method embodiment. Steps may also be omitted, combined, renamed, regrouped, or otherwise depart from the illustrated flow, provided that the method performed is operable and conforms to at least one claim.

Examples are provided herein to help illustrate aspects of the technology, but the examples given within this document do not describe all possible embodiments. Embodiments are not limited to the specific implementations, arrangements, displays, features, approaches, or scenarios provided herein. A given embodiment may include additional or different features, mechanisms, and/or data structures, for instance, and may otherwise depart from the examples provided herein.

During a project factory locating step 402, an embodiment locates a collaborative project factory, such as a factory 302. Step 402 may be accomplished using a registry, catalog, or other mechanism, for example.

During an extension factory identifying step 404, an embodiment identifies a collaborative project extension factory, such as an extension artifact factory 306. Step 404 may be accomplished using mechanisms such as those used to perform step 402.

During an artifact creating step 406, an embodiment creates an instance of a collaborative project extension artifact, such as an artifact 308. Step 406 may be accomplished, for example, by invoking a constructor obtained during step 404. The creating step 406 may create an instance of a web part, a workflow, or a mapped folder, for example, in a particular embodiment.

During a deploying step 408, an embodiment deploys a project extension 138 (e.g., an artifact 308) and/or deploys an extended project 136.

During an executing step 410, an embodiment executes at least a portion of a project extension 138 (e.g., an artifact 308 or artifact factory 306) and/or executes at least a portion of an extended project 136.

During a debugging step 412, an embodiment provides information tailored for debugging at least a portion of a project extension (e.g., an artifact 308 or artifact factory 306) and/or at least a portion of an extended project 136.

During a modifying step 414, an embodiment receives information tailored for modifying at least a portion of a project extension (e.g., an artifact 308 or artifact factory 306) and/or at least a portion of an extended project 136.

During a manifest providing step 416, an embodiment provides a manifest 418 identifying features of an artifact. In some embodiments, a manifest identifies properties of a SharePoint® package or feature, which may include references to other artifacts in the project. Step 416 may be accomplished, for example, using an API which includes definitions such as the following:

```
  public interface IFeatureElement {
    string Location { get; set; }
  }
  public interface IFeature: IFeatureManifest {
    IActivationDependencyReferenceCollection
ActivationDependencyReferences { get; }
    Error! Reference source not found.
ProjectItemReferences { get; }
    bool IsDesignerEnabled { get; set; }
    string Name { get; set; }
  }
  public interface IFeatureActivationDependencyReference:
Error! Reference source not found. {
    Guid ItemId { get; set; }
    Guid ProjectId { get; set; }
  }
  public interface IFeatureManifest {
    bool ActivateOnDefault { get; set; }
    Error! Reference source not found.
ActivationDependencies { get; }
    bool AlwaysForceInstall { get; set; }
    bool AutoActivateInCentralAdmin { get; set; }
    string Creator { get; set; }
    string DefaultResourceFile { get; set; }
    string Description { get; set; }
    IFeatureElementCollection Elements { get; }
    Guid FeatureId { get; set; }
    bool Hidden { get; set; }
    Uri ImageUrl { get; set; }
    string ImageUrlAltText { get; set; }
    Error! Reference source not found. Properties { get;
}
    string ReceiverAssembly { get; set; }
    string ReceiverClass { get; set; }
    bool RequireResources { get; set; }
    FeatureScope Scope { get; set; }
    Guid SolutionId { get; set; }
    string Title { get; set; }
    Version Version { get; set; }
  }
  public interface IFeatureProperty {
    string Key { get; set; } string Value { get; set; }
  }
  public enum FeatureScope {
    Web, Farm, WebApplication, Site,
  }
  public interface
IActivationDependencyReferenceCollection:
IList<IActivationDependencyRef> {
    Error! Reference source not found.
AddCustomActivationDependencyReference( );
    IFeatureActivationDependencyReference
AddFeatureActivationDependencyReference( );
  }
  public interface IFeatureElementCollection:
IList<IFeatureElement> {
    Error! Reference source not found. AddElementFile( );
    Error! Reference source not found.
AddElementManifest( );
  }
```

During a library creating step 420, an embodiment creates a dynamically linked library file or other library file. In some configurations, step 420 creates a class library project configured with a custom action which is designed to at least partially implement a collaborative project extension.

During an extension creating step 422, an embodiment creates at least a portion of a collaborative project extension. In some configurations, step 422 creates an extension using a class library project configured with a custom action resulting from step 420.

During a factory creating step 424, an embodiment creates a factory, such as a factory 306, for a collaborative project extension. In some configurations, the factory is configured with an export attribute, allowing the factory to be found within a composition container 132. The factory is not per se exported; a component exports the specific contract to be bound or discovered in a composition container.

During a context menu item creating step 426, an embodiment creates a context menu item 428 for a collaborative project extension.

During an integration testing step 430, an embodiment exercises project code to help a developer test whether an extension to a collaborative project is integrated with the collaborative project, e.g., whether control flows to the extension as desired.

During an IDE using step 432, use is made of an integrated development environment to help debug, modify, or otherwise exercise a collaborative project extension.

During a memory configuring step 434, a memory 112 is configured by an artifact factory 306, an artifact 308, or otherwise in connection with a collaborative project extension as discussed herein.

During an extensibility framework using step 436, use is made of an extensibility framework 130, such as the Microsoft MEF framework 130, for example, to help load, bind, execute, deploy, or otherwise exercise a collaborative project extension.

The foregoing steps and their interrelationships are discussed in greater detail below, in connection with various embodiments.

Some embodiments provide a method for development of an extensible project 136 in a browser-based collaborative environment 134 which configures a networked computing system. The method includes locating 402 a collaborative project factory; identifying 404 a collaborative project extension artifact factory at least in part based on the collaborative project factory; and creating 406 an instance of a collaborative project extension artifact in a composition container in the networked computing system, at least in part based on the collaborative project extension artifact factory. In one embodiment, for example, the browser-based collaborative environment is a SharePoint® environment; the collaborative project factory is a SharePoint® project factory; the collaborative project extension artifact factory is an IProjectItem factory; the collaborative project extension artifact is an IProjectItem (e.g., a WorkFlow project item); and the composition container is a MEF container, a.k.a. a component domain. In some embodiments, the composition container is created 406 in the developer environment (e.g., a Microsoft Visual Studio® environment), not in the collaborative environment (e.g., a SharePoint® environment).

In some embodiments, the method includes one or more project development lifecycle steps, such as deploying 408 a collaborative project 136 which contains an instance of the collaborative project extension artifact, executing 410 such a collaborative project, debugging 412 such a collaborative project, or modifying 414 such a collaborative project. In some embodiments, the method provides 416 a feature manifest which specifies, in a format consumable by a composition container value resolver, at least one feature of the collaborative project extension artifact. For example, a SharePoint® project extension may interact with other components in MEF using an IFeatureManifest API interface.

In some embodiments, a developer can extend the SharePoint® projects and tools in Visual Studio® by creating SharePoint® project extensions and/or SharePoint® Explorer extensions. SharePoint® project extensions are custom development features that are integrated into the SharePoint® project system provided by Visual Studio®, such as project items that can be used by other developers to create a specific SharePoint® solution, or context menu items for SharePoint® project item nodes in a Solution Explorer. Thus, a developer can create the components needed for a specific SharePoint® solution, and provide these components to other developers so they can create these SharePoint® solutions in Visual Studio®. Likewise, a developer can create a new Visual Studio® feature that can be used at design time, such as a designer for a specific SharePoint® component, and associate that feature with a node in Solution Explorer. In some embodiments, provision new designers are associated with extensions using an underlying Visual Studio® project extensibility mechanism.

While creating extensions for the Visual Studio® projects and tools for SharePoint®, a developer may use APIs of different object models 206, 218. A core automation object model for Visual Studio® is defined in the EnvDTE.dll, EnvDTE80.dll, and EnvDTE90.dll assemblies, which provide APIs used to automate Visual Studio® projects and the IDE at run time. Core object models for Windows SharePoint® Services include a server-side model and a client-side model.

An object model for SharePoint® projects and tools in Visual Studio® defines the behavior of the SharePoint® project system and SharePoint® Explorer, with several assemblies. A Microsoft.VisualStudio.Tools.SharePoint.dll assembly contains APIs used to extend the SharePoint® project system and SharePoint® Explorer, including API interfaces to implement to create an extension, and interfaces that represent objects in the project system and explorer. A Microsoft.VisualStudio.Tools.SharePoint.Explorer.Framework.dll assembly defines base classes one can use when creating a SharePoint® Explorer extension. Other assemblies implement functionality of SharePoint® solutions in Visual Studio®, including the project system and explorer. These assemblies contain primarily internal types, which a developer is unlikely to interact with directly.

To create a SharePoint® project extension in one embodiment, one first creates 420 a new Visual Studio® project, using C# or Visual Basic, for example, with a Class Library template and a name such as CustomAction. Visual Studio® adds the CustomAction project to Solution Explorer and opens the default Class1 code file. Next, delete the Class1 code file from the project, and add three new code files to the project, named in this example CustomAction, CustomActionFactory, and CustomActionMenu. Using a .NET tab of an Add Reference dialog, add System.ComponentModel.Composition and System.Windows.Forms. Unload the project, add <Reference Include=“Microsoft.VisualStudio.Tools.SharePoint”/> to the CustomAction.csproj file, and reload the project. In the CustomAction code file, add the following:

```
using System;
using System.ComponentModel;
using System.Windows.Forms;
using Microsoft.VisualStudio.Tools.SharePoint;
namespace Contoso.CustomAction {
  public class CustomAction :
ISharePointProjectItemExtension {
    public ISharePointProjectItem thisProjectItem;
    public CustomAction(ISharePointProjectItem
projectItem) {
      thisProjectItem = projectItem;
      if (thisProjectItem != null) {
        MessageBox.Show(“Thank you for using the
Contoso custom action.”,
          “Contoso Custom Action”);
        thisProjectItem.Project.PropertyChanged +=
          new
PropertyChangedEventHandler(Project_PropertyChanged);
      }
    }
    void Project_PropertyChanged(object sender,
PropertyChangedEventArgs e) {
      MessageBox.Show(“The following property was
changed: ” + e.PropertyName,
        “Contoso Custom Action”);
    }
    object
ISharePointProjectItemExtension.BrowsableObject {
      get
      {
        return null;
      }
    }
    void ISharePointProjectItemExtension.OnDeployed( ) {
      return;
    }
    void ISharePointProjectItemExtension.OnDeploying(out
bool cancel) {
      cancel = false;
    }
    ISharePointPersistData
ISharePointProjectItemExtension.PersistSettings {
      get
      {
        return null;
      }
    }
    Uri ISharePointProjectItemExtension.StartupUrl {
      get
      {
        return new Uri(“http://localhost”);
      }
    }
  }
}
```

It will be understood that the custom action code herein provides merely one small example among many possible custom actions. In practice, a custom action would likely do more work. The CustomAction class implements the Microsoft.VisualStudio.Tools.SharePoint.SharePointProjectItemExtension interface, which is a requirement of SharePoint® project extensions in this embodiment. The constructor receives a Microsoft.VisualStudio.Tools.SharePoint.ISharePointProjectItem object, and stores it in field for later use. This object provides access to events and functionality that are exposed by the project item that represents an extension. One can access events and functionality of the project itself by using the Project property, which returns a Microsoft.VisualStudio.Tools.SharePoint.ISharePointProject object. The class handles the PropertyChanged event. The event handler displays a message when the user changes a property of the project that contains the extension. One can handle this and other events of the ISharePointProjectItem and ISharePointProject objects to run code when users perform certain tasks at run time.

Next, in this embodiment, one creates 424 a factory class for the SharePoint® project extension. Replace the CustomActionFactory code file content with the following:

```
using System;
using System.ComponentModel.Composition;
using Microsoft.VisualStudio.Tools.SharePoint;
namespace Contoso.CustomAction
{
  [Export(typeof(ISharePointProjectItemExtensionFactory))]
  [SharePointProjectItemExtension(“Contoso.CustomAction”)]
  class CustomActionFactory :
ISharePointProjectItemExtensionFactory
  {
    public ISharePointProjectItemExtension
CreateProjectItemExtension(
      ISharePointProjectItem projectItem)
    {
      return new CustomAction(projectItem);
    }
    public SharePointDeploymentScopes
SupportedDeploymentScopes
    {
      get
      {
        return SharePointDeploymentScopes.Farm |
SharePointDeploymentScopes.WebApplication |
        SharePointDeploymentScopes.Site |
        SharePointDeploymentScopes.Web;
      }
    }
  }
}
```

The CustomActionFactory class is a factory class that Visual Studio® uses to discover and create the extension. This factory class implements the Microsoft.VisualStudio.Tools.SharePoint.ISharePointProjectItemExtensionFactor y interface. In particular, the ISharePointProjectItemExtensionFactory.CreateProjectItemExtension method returns an instance of the project extension class. This factory class has the System.ComponentModel.Composition.ExportAttribute, which specifies the type that will be discovered and instantiated by Visual Studio® MEF as a SharePoint® project extension at run time. In this embodiment, all project extensions specify the ISharePointProjectItemExtensionFactory type. ExportAttribute is an addition to the Microsoft .NET Framework 4.0. This factory class has the Microsoft.VisualStudio.Tools.SharePoint.SharePointProjectItemExtensionAttribut e, which identifies the name of the project extension. In this embodiment, this string should match the value of the ArtifactType attribute of the Artifact element in a .artx file for the project extension.

Next, in this embodiment, one creates 426 a class that defines a context menu item 428 for the project extension in Solution Explorer by replacing the code in the CustomActionMenu code file with the following:

```
using System;
using System.Windows.Forms;
using System.ComponentModel.Composition;
using Microsoft.VisualStudio.Tools.SharePoint;
namespace Contoso.CustomAction
{
  [Export(typeof(ISharePointProjectItemMenuExtension))]
[SharePointProjectItemMenuExtension(“Contoso.CustomAction”)]
  public class CustomActionMenu :
ISharePointProjectItemMenuExtension
  {
    public void
AddMenuCommands(ISharePointMenuCommandContainer menuItems)
    {
      menuItems.AddMenuCommand(
        SharePointMenuCommandSet.ViewItems,
        “View Custom Action Designer”,
ViewDesigner);
    }
    private void ViewDesigner(object sender,
SharePointProjectItemEventArgs e)
    {
      MessageBox.Show(“You could perform some related
task here, ” +
        “such as displaying a designer for the
custom action.”,
        “Contoso Custom Action”););
    }
  }
}
```

The CustomActionMenu class has characteristics required by all extensions in this embodiment that add context menu items to SharePoint® project items in Solution Explorer. This CustomActionMenu class implements the Microsoft.VisualStudio.Tools.SharePoint.ISharePointProjectItemMenuExtension interface. This class has the ExportAttribute, which specifies the type that will be discovered and instantiated by Visual Studio® as a context menu for a SharePoint® project item at run time. Context menus for SharePoint® project items specify the ISharePointProjectItemMenuExtension type. This CustomActionMenu class has the Microsoft.VisualStudio.Tools.SharePoint.SharePointProjectItemMenuExtensionAt tribute. The parameter for this attribute identifies the project item that the context menu item will be added to. When adding a menu item to a custom project item, the string passed to this attribute should match the string passed to the SharePointProjectItemExtensionAttribute on the factory class.

In this embodiment, to build and deploy the SharePoint® project extension, one first builds the project and verifies there are no errors. One then copies the CustomAction.dll assembly from the project's build folder to an appropriate IDE extensions folder to deploy the extension, similar to building and deploying other Visual Studio® projects 136.

To test 430 integration of the project extension, in an instance of Visual Studio® that does not have the CustomAction project open, create a new SharePoint® project with a URL of a local site to use for debugging, add the CustomAction item, and verify that code in another instance of Visual Studio® running the CustomAction project stops on a breakpoint previously set in the CreateProjectItemExtension method. Continue, and verify that a message box created by the CustomAction constructor is displayed. Continue verifying additional functionality of the extension as desired, e.g., verify the presence of a message box displayed by the PropertyChanged event handler defined in the CustomAction class. An extension could handle this and other events to run code when a developer modifies the project or item in certain ways.

Configured Media

Some embodiments include a configured computer-readable storage medium 114, which is an example of a memory 112. Memory 112 may include disks (magnetic, optical, or otherwise), RAM, EEPROMS or other ROMs, and/or other configurable memory. The storage medium which is configured may be in particular a removable storage medium 114 such as a CD, DVD, or flash memory. A general-purpose memory 112, which may be removable or not, and may be volatile or not, can be configured into an embodiment using items such as extension artifact factories 306, artifacts 308, and extensibility APIs 216, in the form of data 118 and instructions 116, read from a removable medium 114 and/or another source such as a network connection, to form a configured medium. The configured memory 112 is capable of causing a computer system to perform method steps for transforming data through value resolution as disclosed herein. FIGS. 1 through 4 thus help illustrate configured storage media embodiments and method embodiments, as well as system and method embodiments. In particular, any of the method steps illustrated in FIG. 3 and/or FIG. 4, or otherwise taught herein, may be used to help configure a storage medium to form a configured medium embodiment.

Some embodiments provide a computer-readable medium 114 configured with data 118 and instructions 116 for performing a method for developing a browser-based collaborative environment project extension. The method includes creating 420 a class library project configured with a custom action; creating 422 a browser-based collaborative environment project extension artifact representing the custom action; and creating 424 a factory class for the project extension artifact, the factory class configured by an export attribute for “export” from a composition container. These steps may be accomplished, for example, as discussed in the foregoing example using SharePoint® and Visual Studio® technologies. The custom action, for example, is developed as a part of a project; the project contains or implements custom action. Such custom action is merely one of the SharePoint® artifacts or elements which can extend the appearance and behavior of a SharePoint® environment. The project may be configured with code for a custom action, code for a custom action factory, and code for a custom action menu, as described above, for example. A context menu item may be created 426 for the project extension artifact in a browser-based collaborative environment solution explorer, as discussed. The method may include building the browser-based collaborative environment project extension and deploying the browser-based collaborative environment project extension in a networked computing system, as also discussed, as well as testing integration of the browser-based collaborative environment project extension with a base project. The method may include creating steps performed with assistance from an integrated development environment, such as a Visual Studio® environment, which configures a computing system.

Conclusion

Although particular embodiments are expressly illustrated and described herein as methods, as configured media, or as systems, it will be appreciated that discussion of one type of embodiment also generally extends to other embodiment types. For instance, the descriptions of methods in connection with FIG. 4 also help describe configured media, and help describe the operation of systems and manufactures like those discussed in connection with other Figures. It does not follow that limitations from one embodiment are necessarily read into another. In particular, methods are not necessarily limited to the data structures and arrangements presented while discussing systems or manufactures such as configured memories.

Not every item shown in the Figures need be present in every embodiment. Conversely, an embodiment may contain item(s) not shown expressly in the Figures. Although some possibilities are illustrated here in text and drawings by specific examples, embodiments may depart from these examples. For instance, specific features of an example may be omitted, renamed, grouped differently, repeated, instantiated in hardware and/or software differently, or be a mix of features appearing in two or more of the examples. Functionality shown at one location may also be provided at a different location in some embodiments.

Reference has been made to the figures throughout by reference numerals. Any apparent inconsistencies in the phrasing associated with a given reference numeral, in the figures or in the text, should be understood as simply broadening the scope of what is referenced by that numeral.

As used herein, terms such as “a” and “the” are inclusive of one or more of the indicated item or step. In particular, in the claims a reference to an item generally means at least one such item is present and a reference to a step means at least one instance of the step is performed.

Headings are for convenience only; information on a given topic may be found outside the section whose heading indicates that topic.

All claims as filed are part of the specification.

While exemplary embodiments have been shown in the drawings and described above, it will be apparent to those of ordinary skill in the art that numerous modifications can be made without departing from the principles and concepts set forth in the claims. Although the subject matter is described in language specific to structural features and/or methodological acts, it is to be understood that the subject matter defined in the appended claims is not necessarily limited to the specific features or acts described above the claims. It is not necessary for every means or aspect identified in a given definition or example to be present or to be utilized in every embodiment. Rather, the specific features and acts described are disclosed as examples for consideration when implementing the claims.

All changes which come within the meaning and range of equivalency of the claims are to be embraced within their scope to the full extent permitted by law.

Alternate API Listing

```
namespace Microsoft.VisualStudio.Tools.SharePoint.Project
{
  public interface INotifyObjectDisposed:
INotyfyPropertyChanged {
    bool IsDisposed { get; }
    event EventHandler Disposed;
  }
  public interface IProject: INotifyObjectDisposed,
INotyfyPropertyChanged {
    Error! Reference source not found.
AssemblyDeploymentTarget { get; set; }
    IProjectFeatureCollection Features { get; }
    string FullPath { get; }
    Image Icon { get; } Guid Id { get; }
    bool IsUserSolution { get; set; }
    IMappedFolderCollection MappedFolders { get; }
    string Name { get; }
    string OutputFullPath { get; }
    IProjectPackage Package { get; }
    IProjectItemCollection ProjectItems { get; }
    IProjectService ProjectService { get; }
    IEnumerable<IProjectItem> SelectedProjectItems {
get; }
    Uri SiteUrl { get; set; }
    IProjectItem StartupProjectItem { get; set; }
    Uri StartupUrl { get; }
    void BeginBatch( ); void EndBatch( );
    event EventHandler<NameChangedEventArgs>
NameChanged;
  }
  public interface IProjectFeature: INotifyObjectDisposed,
INotyfyPropertyChanged {
    string FullPath { get; }
    Image Icon { get; } Guid Id { get; }
    string Name { get; }
    IProject Project { get; }
    IFeature Model { get; }
    Error! Reference source not found.<IProjectItem>
ProjectItems { get; }
    event EventHandler<NameChangedEventArgs> NameChanged;
  }
  public interface IProjectItem: INotifyObjectDisposed,
INotyfyPropertyChanged {
    IProjectItemFile DefaultFile { get; set; }
    IProjectItemDefinition Definition { get; }
    IDictionary<object,object> Annotations { get; }
    IDictionary<string,string> ExtensionData { get; }
    IDictionary<string,string> ProjectUserData { get; }
    IDictionary<string,string> FeatureProperties { get;}
    string FeatureReceiverAssembly { get; set; }
    string FeatureReceiverClassName { get; set; }
    IProjectItemFileCollection Files { get; }
    string FullPath { get; }
    Image Icon { get; } Guid Id { get; }
    bool IsExpanded { get; set; }
    string Name { get; }
    IProject Project { get; }
    string ProjectItemType { get; }
    IProjectOutputReferenceCollection
ProjectOutputReferences { get; }
    ISafeControlEntryCollection SafeControlEntries {
get; }
    Uri StartupUrl { get; set; }
    SupportedDeploymentScopes SupportedDeploymentScopes
{ get; }
    event EventHandler<NameChangedEventArgs>
NameChanged;
    event EventHandler<ProjectItemOpenedEventArgs>
Opened;
  }
  public interface IProjectItemFile: Error! Reference
source not found., INotifyObjectDisposed,
INotyfyPropertyChanged {
    Image Icon { get; }
    string Name { get; }
    IProjectItem ProjectItem { get; }
    string Source { get; }
    IDictionary<object,object> Annotations { get; }
    event EventHandler<NameChangedEventArgs>
NameChanged;
  }
  public interface IProjectOutputReference: Error!
Reference source not found., INotifyObjectDisposed,
INotyfyPropertyChanged {
    string ProjectFullPath { get; }
    Guid ProjectId { get; set; }
    IProjectItem ProjectItem { get; }
  }
  public interface IProjectPackage: INotifyObjectDisposed,
INotifyPropertyChanged {
    string FullPath { get; }
    Image Icon { get; } Guid Id { get; }
    string Name { get; }
    IProject Project { get; }
    Error! Reference source not found. Model { get; }
    Error! Reference source not found.<IProjectFeature>
Features { get; }
    Error! Reference source not found.<IProjectItem>
ProjectItems { get; }
  }
  [System.Runtime.InteropServices.GuidAttribute(guid)]
  public interface IProjectService {
    IProjectCollection Projects { get; }
    TOutput Convert<TInput,TOutput>(TInput value);
  }
  public interface ISafeControlEntry:
INotifyObjectDisposed, INotifyPropertyChanged {
    string Assembly { get; set; }
    string NamespaceValue { get; set; }
    IProjectItem ProjectItem { get; }
    string TypeName { get; set; }
  }
  [System.FlagsAttribute( )]
  public enum SupportedDeploymentScopes {
    Package,
    WebFeature,
    SiteFeature,
    WebApplicationFeature,
    FarmFeature,
  }
  public enum DeploymentType {
    NoDeployment,
    ElementManifest,
    ElementFile,
    TemplateFile,
    RootFile,
  }
  public enum MappedFolderType {
    Other,
    ControlTemplates,
    Images,
    Layouts,
    SharePointRoot,
    Template,
  }
  public interface IReadOnlyCollection<T>: IEnumerable<T>,
INotifyCollectionChanged, INotifyPropertyChanged {
    int Count { get; }
    bool Contains(T item);
    void CopyTo(T[ ] array, int index);
  }
  public interface IMappedFolderCollection:
IReadOnlyCollection<Error! Reference source not found.> {
    IProject Project { get; }
    Error! Reference source not found.
Add(MappedFolderType folderType);
    Error! Reference source not found.
Add(MappedFolderType folderType, bool skipAutoPackage);
    Error! Reference source not found. Add(string
deploymentPath);
    Error! Reference source not found. Add(string
deploymentPath, bool skipAutoPackage);
  }
  [System.Reflection.DefaultMemberAttribute(“Item”)]
  public interface IProjectCollection:
IReadOnlyCollection<IProject> {
    IProjectService ProjectService { get; }
    IProject this[string fullPath] { get; }
    IProject Find(Guid id);
  }
  [System.Reflection.DefaultMemberAttribute(“Item”)]
  public interface IProjectFeatureCollection:
IReadOnlyCollection<IProjectFeature> {
    IProject Project { get; }
    IProjectFeature this[string fileName] { get; }
    IProjectFeature Add( );
    IProjectFeature Add(bool skipAutoPackage);
    IProjectFeature Find(Guid id);
  }
  [System.Reflection.DefaultMemberAttribute(“Item”)]
  public interface IProjectItemCollection:
IReadOnlyCollection<IProjectItem> {
    IProject Project { get; }
    IProjectItem this[string fileName] { get; }
    IProjectItem Add(string name, string
projectItemType);
    IProjectItem Add(string name, string
projectItemType, bool skipAutoPackage);
    IProjectItem Find(Guid id);
  }
  [System.Reflection.DefaultMemberAttribute(“Item”)]
  public interface IProjectItemFileCollection:
IReadOnlyCollection<IProjectItemFile> {
    IProjectItem ProjectItem { get; }
    IProjectItemFile this[string fileName] { get; }
    IProjectItemFile AddFromFile(string fileName);
    IProjectItemFile AddFromFileCopy(string fileName);
    IProjectItemFile AddFromFileCopy(string fileName,
string subdirectory);
  }
  public interface IProjectOutputReferenceCollection:
IReadOnlyCollection<IProjectOutputReference> {
    IProjectItem ProjectItem { get; }
    IProjectOutputReference Add(Guid projectId,
DeploymentType deploymentType);
    IProjectOutputReference Add(IProject project,
DeploymentType deploymentType);
    IProjectOutputReference Add(string projectFullPath,
DeploymentType deploymentType);
  }
  public interface ISafeControlEntryCollection:
IReadOnlyCollection<ISafeControlEntry> {
    IProjectItem ProjectItem { get; }
    ISafeControlEntry Add(string namespaceValue, string
typeName);
    ISafeControlEntry Add(string namespaceValue, string
typeName, string assembly);
    bool Remove(ISafeControlEntry entry);
  }
  public class NameChangedEventArgs : EventArgs {
    NameChangedEventArgs(string oldName);
    string OldName { get; set; }
  }
  public class ProjectItemEventArgs : EventArgs {
    ProjectItemEventArgs(IProjectItem projectItem);
    IProjectItem ProjectItem { get; set; }
  }
  public class ProjectItemOpenedEventArgs : EventArgs {
    ProjectItemOpenedEventArgs(bool handled);
    bool Handled { get; set; }
  }
[System.AttributeUsageAttribute((System.AttributeTargets)4,
AllowMultiple = False, Inherited = False)]
[System.ComponentModel.Composition.MetadataAttributeAttribute
( )]
  public sealed class ProjectItemAttribute : Attribute,
_Attribute, IProjectItemMetadata {
    ProjectItemAttribute(string projectItemType);
    string ProjectItemType { get; set; }
  }
[System.ComponentModel.Composition.MetadataAttributeAttribute
( )]
[System.AttributeUsageAttribute((System.AttributeTargets)4,
AllowMultiple = False, Inherited = False)]
  public sealed class AllProjectItemsAttribute :
Attribute, _Attribute, IProjectItemMetadata {
    AllProjectItemsAttribute( );
    string ProjectItemType { get; }
  }
  public interface IProjectItemMetadata {
    string ProjectItemType { get; }
  }
  public interface IProjectItemDefinition :
IProjectItemExtension {
    SupportedDeploymentScopes SupportedDeploymentScopes
{ get; }
    Uri GetStartupUrl(IProjectItem projectItem);
  }
  public interface IProjectItemExtension {
    void OnInitilized(IProjectItem projectItem);
    void OnDisposed(IProjectItem projectItem);
    IProjectItemBrowsableObjectProvider
BrowsableObjectProvider { get; }
    IProjectItemDeploymentExtension DeploymentExtension
{ get; }
    IProjectItemMenuExtension MenuExtension { get; }
  }
  public interface IProjectItemBrowsableObjectProvider {
    object GetBrowsableObject(IProjectItem projectItem);
  }
  public interface IProjectItemDeploymentExtension {
    void OnDeploying(IProjectItem projectItem, ref bool
cancel);
    void OnDeployed(IProjectItem projectItem);
  }
  public interface IProjectItemMenuExtension {
    void Initialize(Error! Reference source not found.
menuItemFactory);
  }
}
```

What is claimed is:

1. A method for development of an extensible project in a browser-based collaborative environment which configures a networked computing system, the method comprising the steps of:
locating a collaborative project factory;
identifying a collaborative project extension artifact factory at least in part based on the collaborative project factory; and
creating an instance of a collaborative project extension artifact in a composition container in the networked computing system, at least in part based on the collaborative project extension artifact factory.

2. The method of claim 1, further comprising at least one of the following project development lifecycle steps:
deploying a collaborative project which contains the instance of the collaborative project extension artifact;
executing a collaborative project which contains the instance of the collaborative project extension artifact;
debugging a collaborative project which contains the instance of the collaborative project extension artifact;
modifying a collaborative project which contains the instance of the collaborative project extension artifact.

3. The method of claim 1, wherein the creating step creates an instance of at least one of the following: a web part, a workflow, a mapped folder.

4. The method of claim 1, further comprising providing a feature manifest which specifies, in a format consumable by a composition container value resolver, at least one feature of the collaborative project extension artifact.

5. A computer-readable medium configured with data and instructions for performing a method for developing a browser-based collaborative environment project extension, the method comprising the steps of:
creating a class library project configured with a custom action;
creating a browser-based collaborative environment project extension artifact representing the custom action; and
creating a factory class for the project extension artifact, the factory class configured with an export attribute.

6. The configured medium of claim 5, wherein creating a class library project configured with a custom action comprises configuring the class library project with code for a custom action, code for a custom action factory, and code for a custom action menu.

7. The configured medium of claim 5, wherein the method further comprises creating a context menu item for the project extension in a browser-based collaborative environment solution explorer.

8. The configured medium of claim 5, wherein the method further comprises building the browser-based collaborative environment project extension and deploying the browser-based collaborative environment project extension in a networked computing system.

9. The configured medium of claim 5, wherein the method further comprises testing integration of the browser-based collaborative environment project extension with a base project.

10. The configured medium of claim 5, wherein at least one of the creating steps is performed with assistance from an integrated development environment which configures a computing system.

11. A computer system comprising:
a logical processor;
a browser-based collaborative environment project configuring memory in operable communication with the logical processor;
a browser-based collaborative environment project extension artifact factory configuring memory in operable communication with the logical processor; and
a browser-based collaborative environment project extension artifact within a composition container which configures memory in operable communication with the logical processor.

12. The system of claim 11, wherein the system comprises code configuring the memory including an API for a browser-based collaborative environment project extension artifact factory.

13. The system of claim 11, wherein the system comprises code configuring the memory capable of managing a collection of browser-based collaborative environment project extension artifacts, wherein the collection is publicly read-only.

14. The system of claim 11, wherein the system comprises code configuring the memory capable of notifying subscribers of changes in a collection of browser-based collaborative environment project extension artifacts.

15. The system of claim 11, wherein the system comprises at least one of the following browser-based collaborative environment project extension artifacts: a web part, a workflow, a mapped folder.

16. The system of claim 11, wherein the system comprises an extensibility framework including a discovery mechanism for locating extensions in composition containers.

17. The system of claim 11, wherein the system comprises an extensibility framework including a mechanism for associating metadata with an extension.

18. The system of claim 11, wherein the system comprises multiple computers connected by a network in a browser-based collaborative environment.

19. The system of claim 11, wherein the system further comprises an integrated development environment which configures memory in operable communication with the logical processor.

20. The system of claim 11, wherein the system comprises code configuring the memory including an API specifically designed for facilitating at least one of the following:
deploying a browser-based collaborative environment project extension;
executing a browser-based collaborative environment project extension;
debugging a browser-based collaborative environment project extension;
modifying a browser-based collaborative environment project extension.
